(19) United States
(12) Patent Application Publication
(10) Pub. No.: US 2009/0316529 A1
(43) Pub. Date: Dec. 24, 2009

(54) Positioning of a Portable Electronic Device

(75) Inventors: Pertti Huuskonen, Tampere (FI); Juha Kaario, Tampere (FI); Janne Kokkala, Espoo (FI)

Correspondence Address: HARRINGTON & SMITH, PC, 4 RESEARCH DRIVE, Suite 202, SHELTON, CT, 06484-6212, US

(73) Assignee: NOKIA CORPORATION, Espoo (FI)

(21) Appl. No.: 11/919,940

(22) PCT Filed: May 12, 2005
(86) PCT No.: PCT/IB2005/001531

§ 371 Date: Aug. 3, 2009

(51) Int. Cl. G01S 3/80

(52) U.S. Cl. 367/124; 367/127

(57) ABSTRACT

An acoustical positioning system for positioning a portable electronic device including a loudspeaker system including three or more loudspeakers and a control unit operable according to a first time reference wherein the control unit controls the transmission of a series of audio beacons from the loudspeakers, wherein a first beacon is transmitted at a first time of the first time reference from a first speaker, a second beacon is transmitted at a second time of the first time reference from a second speaker, and a third beacon is transmitted at a third time of the first time reference from a third speaker; at least one portable electronic device operable according to a second time reference and including a synchronizer for synchronising the second time reference to the first time reference; a microphone for receiving the transmitted series of audio beacons; a detector for detecting the time according to the second time reference at which an audio beacon is received and for identifying the origin of the received audio beacon, wherein the first beacon is received at a fourth time according to the second time reference, the second beacon is received at a fifth time according to the second time reference, and the third beacon is received at a sixth time according to the second time reference; and a unit for determining a position of the portable device using relative positions of the first, second and third speakers and the difference between the first time and the fourth time, between the second time and the fifth time, and between the third time and the sixth time.

### FIELD OF THE INVENTION

Embodiments of the present invention relate to positioning a portable electronic device.

### BACKGROUND TO THE INVENTION

The positioning of portable electronic devices is possible in a number of different ways.

One option is to have a dedicated network of radio transmitters arranged for example as a grid. The position of a device can be determined from the nearest transmitter. A disadvantage with this option is that either a very large number of transmitters are required or the positional accuracy is poor.

This problem has been addressed in mobile cellular telecommunication networks by measuring the distance of a mobile cellular telephone from a number of different base stations and then calculating the position of the mobile cellular telephone from the distances. Disadvantages associated with this option are that it is controlled by a network operator, it is generally unsuitable for indoor use because of multi-path signals and/or attenuation and it is generally only suitable for positioning a device with an accuracy of approximately 100 m.

Another option is to install a GPS device within the portable electronic device. A GPS device determines its location from geo-stationary satellites. Disadvantages associated with this option are that the GPS system may be switched off an any time or its accuracy degraded deliberately by the US government, it is unsuitable for use indoors because a direct lines of sight to the satellites are required and it is generally unsuitable for positioning a device with an accuracy greater than 10 m.

### BRIEF DESCRIPTION OF THE INVENTION

It would be desirable to provide an alternative option for positioning a portable electronic device.

According to one embodiment of the invention there is provided an acoustical positioning system for positioning a portable electronic device comprising: a loudspeaker system comprising three or more loudspeakers and a control unit operable according to a first time reference wherein the control unit controls the transmission of a series of audio beacons from the loudspeakers, wherein a first beacon is transmitted at a first time of the first time reference from a first speaker, a second beacon is transmitted at a second time of the first time reference from a second speaker, and a third beacon is transmitted at a third time of the first time reference from a third speaker; at least one portable electronic device operable according to a second time reference and comprising:

synchronisation means for synchronising its second time reference to the first time reference; a microphone for receiving the transmitted series of audio beacons; means for detecting the time according to the second time reference at which an audio beacon is received and for identifying the origin of the received audio beacon, wherein the first beacon is received at a fourth time according to the second time reference, the second beacon is received at a fifth time according to the second time reference, and the third beacon is received at a sixth time according to the second time reference; and
means for determining a position of the portable device using relative positions of the first, second and third speakers and the difference between the first time and the fourth time, between the second time and the fifth time, and between the third time and the sixth time.

The acoustical positioning system may be used indoors. The use of acoustic signals can be used to position a portable electronic device to an accuracy of at least 0.5 m, however the area/volume in which a device can be positioned with such accuracy typically has maximum dimensions of about 100 m.

The loudspeaker system may be part of a surround-sound home-entertainment system.

The acoustical positioning system may thus advantageously re-use existing infrastructure within the home.

According to another embodiment of the invention there is provided a portable electronic device, for determining its position via a loudspeaker system that operates according to a first time reference and that transmits a series of audio beacons from loudspeakers, the portable electronic device being operable according to a second time reference and comprising: synchronisation means for synchronising its second time reference with the first time reference; a microphone for receiving a transmitted series of audio beacons;

means for detecting the time according to the second time reference at which an audio beacon is received and for identifying the loudspeaker that transmitted the received audio beacon; and means for determining a position of the portable device using the relative positions of the loudspeakers and the differences between the time of transmission and the time of receipt for a plurality of audio beacons from at least three loudspeakers.

The acoustical positioning system does not necessarily require the addition of new hardware to the portable electronic device, so that it can determine its position after a software upgrade without upgrade to its hardware.

According to another embodiment of the invention there is provided a computer program comprising computer program instructions which when loaded into a processor provide:

synchronisation means for synchronising a local time reference with a remote time reference; means for processing the output of a microphone to detect the times according to the local time reference at which audio beacons transmitted from loudspeakers are received by the microphone and for identifying, for each received audio beacon, the loudspeaker that transmitted that audio beacon; and means for determining a position of the portable device using relative positions of the loudspeakers and the differences between the time of transmission and the time of receipt for a plurality of audio beacons from at least three loudspeakers.

### BRIEF DESCRIPTION OF THE DRAWINGS

For a better understanding of the present invention reference will now be made by way of example only to the accompanying drawings in which:

FIG. 1 illustrates an acoustical positioning system for positioning a portable electronic device 10 using a loudspeaker system comprising multiple loudspeakers 4 and a control unit 2;

FIG. 2 illustrates the portable electronic device in more detail;

FIG. 3 illustrates vector displacements used in the determination of the position of an electronic device; and

FIG. 4 illustrates the timing of the transmission and reception of a series of audio beacons.

### DETAILED DESCRIPTION OF EMBODIMENTS OF THE INVENTION

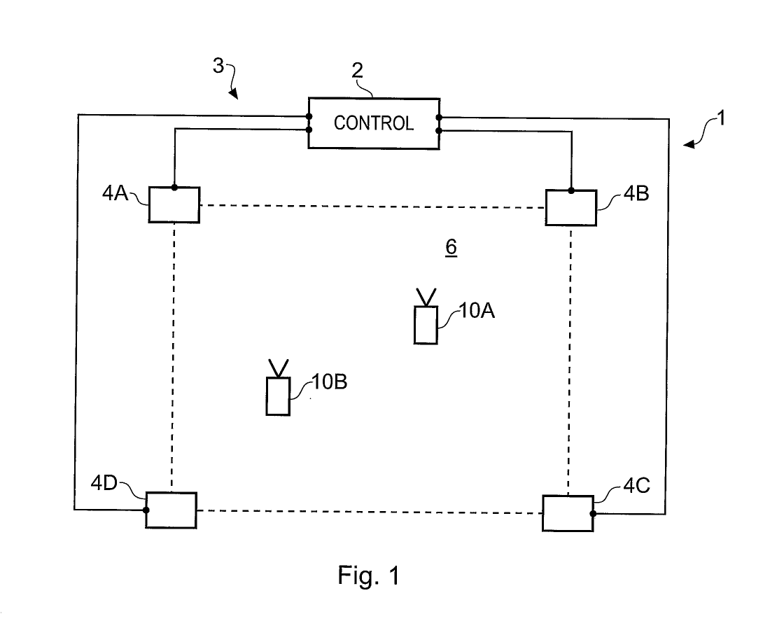

FIG. 1 illustrates an acoustical positioning system 1 for positioning a portable electronic device 10. The system 1 comprises one or more electronic devices 10 and a loudspeaker system 3 comprising multiple loudspeakers 4 and a control unit 2.

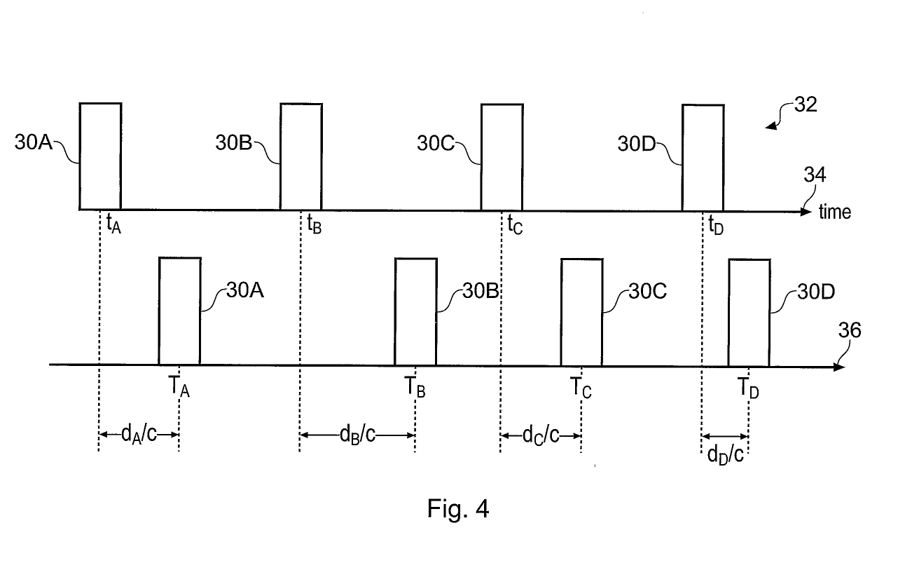

The control unit 2 operates according to a first time reference 34 and controls the transmission of a series 32 of audio beacons 30 from the loudspeakers 4. As illustrated in FIG. 4 a first beacon 30A is transmitted at a time t_{A} of the first time reference 34 from a first speaker 4A, a second beacon 30B is transmitted at a time t_{B} of the first time reference 34 from a second speaker 4B, a third beacon 30C is transmitted at a time t_{C} of the first time reference 34 from a third speaker 4C and a fourth beacon 30D is transmitted at a time t_{D} of the first time reference 34 from a fourth speaker 4D.

The hand-portable electronic device 10A operates according to a second time reference 36 and comprises: synchronisation means for synchronising its second time reference 36 to the first time reference 34; a microphone 24 for receiving the transmitted series 32 of audio beacons 30; means for detecting the time T according to the second time reference 36 at which an audio beacon 30 is received and for identifying the loudspeaker 4 that transmitted the received audio beacon 30 and means for determining a position p of the portable device 10A. The first beacon 30A is received at a time T_{A} according to the second time reference 36, the second beacon 30B is received at a time T_{B} according to the second time reference 36, the third beacon 30C is received at a time T_{C} according to the second time reference 36 and the fourth beacon 30D is received at a time T_{D} according to the second time reference 36 and the means for determining a position p of the portable device 10A uses relative positions of the loudspeakers 4A, 4B, 4C and 4D and the difference between t_{A} and T_{A}, between t_{B} and T_{B}, between t_{C} and T_{C} and between t_{D} and T_{D}.

In more detail, the control unit 2 communicates separately with each of the loudspeakers 4 either wirelessly or via galvanic interconnects. The control unit 2 controls what a loudspeaker transmits and when it transmits it.

The operational range of good quality loudspeakers extends above 20 kHz. However, above 18-20 kHz transmitted sound is generally inaudible to a human and is referred to as ultrasound. Consequently, the control unit can control the loudspeakers to transmit either audible sound or inaudible ultrasound.

An audio beacon 30 allows a portable electronic device that receives it to identify the time the audio beacon 30 took to reach it from transmission and from where it was transmitted. The control unit 2 controls each of the loudspeakers 4 to intermittently transmit an audio beacon 30. These audio beacons in combination form a series of audio beacons 30. If the audio beacons 30 are transmitted as audible sound they may be integrated into music.

The problem of determining the time an audio beacon 30 takes to reach a portable electronic device 10 from transmission can be solved in a number of ways. The first step is to synchronise the second time reference 36 of the portable electronic device 10 to the first time reference 34. Synchronization in this sense means determining the offset between the time references so that a time according to the one time reference can be translated into a time according to the other time reference. This allows a common (shared) time reference to be defined. The next step is to determine the time at which the audio beacon 30 was transmitted according to the common time reference and the time at which the audio beacon was received according to the common time reference. The difference between these determined times, when multiplied by the speed of sound in air, provides a measure of the distance between the portable electronic device 10 and the loudspeaker 4 that transmitted the beacon 30.

The time at which the audio beacon 30 was received according to the common time reference can be determined by identifying the time at which the beacon was received according to the second time reference and converting this, if necessary, to the common time reference. The time at which a beacon is received may be identified by detecting the moment of receipt and reading a value of a clock 20 at that moment. The moment of receipt may be detected, for example, by detecting when the ultrasonic components of the audio input to a microphone 24 exceed a threshold. Alternatively, the audio beacon 30 may be formed by modulating a carrier wave in a predetermined fashion and a correlator may be used to detect this distinctive modulation.

The time at which the beacon was transmitted according to the common time reference can be determined from the time at which the beacon was transmitted according to the first time reference and by converting this, if necessary, to the common time reference.

The time at which a beacon was transmitted may be determined from a time stamp included in the beacon. The time stamp information may be included as modulations of

an acoustic carrier wave. Alternatively, the time at which an audio beacon was transmitted may be determined by identifying the position of the received audio beacon within a predetermined series of beacons, and synchronising the second time reference to the series. The series of audio beacons may include a synchronisation code to enable this. The position of a received audio beacon within the series is simply converted to a time within the second time reference.

The problem of determining the identity of the loudspeaker from which the beacon was transmitted can be solved in a number of ways. Each beacon could, for example, include an identifier identifying the loudspeaker 4 from which it was transmitted. The identifier would be included as modulations of an acoustic carrier wave. Another solution is to transmit from the loudspeakers in a predetermined order. Identifying the position of the received beacon within a predetermined ordered series of beacons would identify the loudspeaker from which it was transmitted.

Thus in one embodiment each audio beacon may include both a time stamp and a speaker identifier. In a different embodiment, the audio beacons may be transmitted as a predetermined ordered series and each beacon includes a time stamp. In a different embodiment, the beacons may be transmitted as a predetermined ordered series with a sync code marking the beginning of the series. This latter embodiment, allows the beacons to be produced from a pre-recorded track that may be loaded into the control unit from a DVD or CD or other acoustic storage medium.

If a predetermined ordered series of beacons is used, then the series may be regular in the sense that the beacons are regularly spaced. The interval between the beacons does not need to exceed 1 second, and in most implementations may be less than 0.3 seconds, for example, between 10 and 20 ms.

In the preceding description, the audio beacons are transmitted in different channels. Channel separation is provided in the example of FIG. 4 in the time domain and, optionally, by using a loudspeaker identifier in an audio beacon 30. In other embodiments, the channels could, for example, be separated in the frequency domain in addition or as an alternative to the time domain.

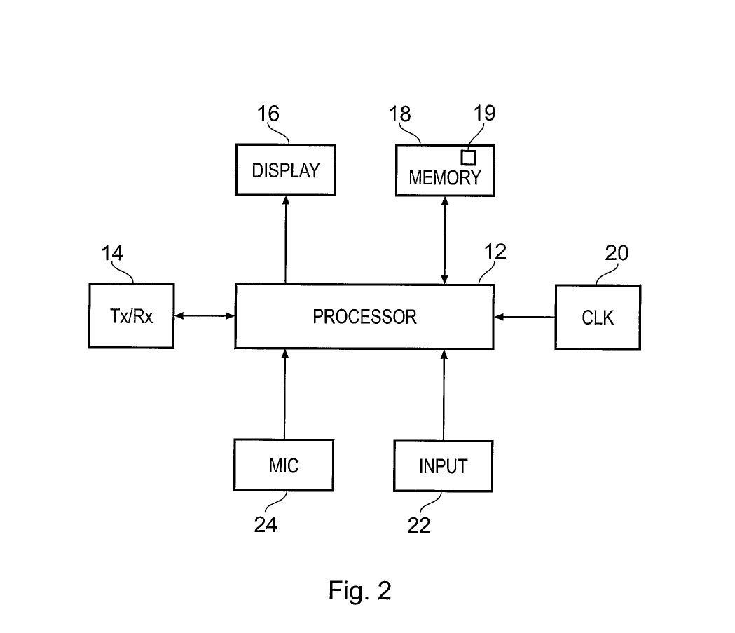

FIG. 2 illustrates the portable electronic device 10A in more detail. The portable electronic device 10A may be a hand-portable electronic device such as a mobile cellular telephone or personal digital assistant or games console. The portable electronic device 10A comprises a processor 12 that is connected to read from and write to a memory 18 and to provide data to and receive data from a radio transceiver 14. The radio transceiver may be, for example, a low power radio frequency transceiver such as a Bluetooth transceiver or, alternatively a cellular radio transceiver. The processor 12 is connected to provide control signals to the display 16 and any other output devices and to receive data or control signals from the clock 20, the user input device 22 and from the microphone 24. The clock 20 defines the second time reference (time base) 36. The user input device 22 may be any suitable device such as a keypad, joystick etc. The microphone 24 must be capable of transducing the audio beacons into electrical signals. If the audio beacons are transmitted at ultrasonic frequencies then the microphone should be capable of operating at such frequencies.

The memory 18 stores computer program instructions 19 which when loaded into the processor 12 control the operation of the device 10A and, in particular, enable the device 10A to convert audio beacons 30 received at the microphone 24 into a position of the device 10A. The computer program instructions may be stored in the memory 18 from a storage medium such as a computer readable carrier e.g. DVD, CD-ROM, etc or may be transferred on an electromagnetic signal received at the radio transceiver 14 for storage in the memory 18.

It should be appreciated that the electronic device 10A may comprise additional or different components or have a different architecture than that described.

An example of an algorithm suitable for positioning the portable electronic device 10A will now be described.

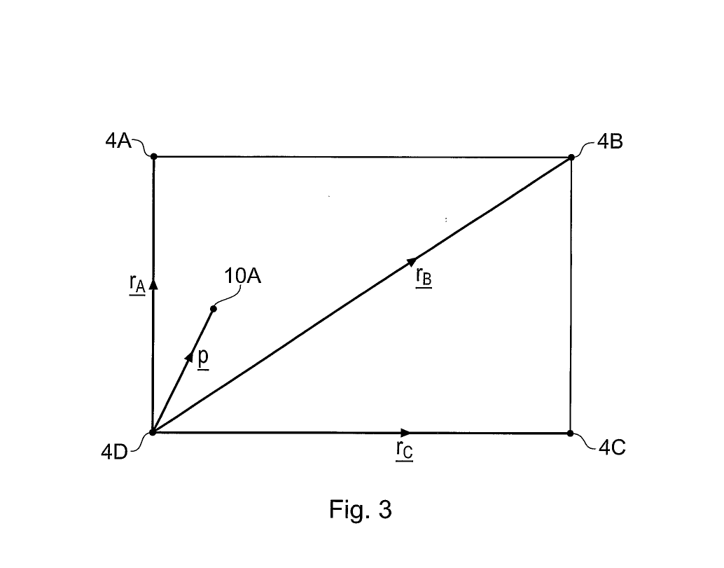

Let us define all vector displacements relative to the position of the loudspeaker 4D as illustrated in FIG. 3.

Let the vector displacement of the mobile electronic device 10A be p, where p is an unknown variable. p is variable as the electronic device 10A is mobile.

Let the vector displacement of the loudspeaker 4A from 4D be r_{A}, the vector displacement of the loudspeaker 4B from 4D be r_{B}, the vector displacement of the loudspeaker 4C from 4D be r_{C}. Where r_{A}, r_{B} and r_{C} are constants that are initially unknown. They are constants because the positions of the loudspeakers 4 are unchanging. The loudspeakers are typically semi-permanently fixed in position.

Let the distance of the portable electronic device (at position p) from 4A be d_{A}, the distance from 4B be d_{B}, the distance from 4C be d_{C} and the distance from 4D be d_{D}. Where d_{A}, d_{B}, d_{C} and d_{D} are variables that are initially unknown. These distances vary as the position of the electronic device 10A varies.

The relationship between the variables and constants is given by:

|p−r_{A}|=d_{A}

|p−r_{B}|=d_{B}

|p−r_{C}|=d_{C}

|p|=d_{D}

where | | indicates the magnitude of the vector it contains.

Let the distance between the loudspeaker 4D and 4A be a, the distance between the loudspeaker 4A and 4B be b, the distance between the loudspeaker 4B and 4C be c, the distance between the loudspeaker 4C and 4D be d, the distance between the loudspeaker 4A and 4C be e, and the distance between the loudspeaker 4B and 4D be f.

If, in a first calibration step, the portable electronic device 10A is initially placed at, for example, the loudspeaker 4A, then p=r_{A} and:

|rₐ−r_{B}|=d_{B}=a

|r_{A}−r_{C}|=d_{C}=b

|r_{A}|=d_{D}=c

where a, b and c are measured values.

a=(Tₐ−t_{B})*cₛ

b=(T_{C}−t_{C})*cₛ

c=(T_{D}−t_{D})*cₛ

where cₛ is the velocity of sound in air at atmospheric pressure (101 325 Pa) and room temperature (20° C.). If necessary cₛ may be varied to reflect ambient conditions such as temperature, air pressure, speed of movement etc.

If, in a second calibration step, the portable electronic device 10A is then placed at, for example, the loudspeaker 4B, then p=r_{B} and:

|r_{B}−r_{A}|=d_{A}=a

|r_{B}−r_{C}|=d_{C}=d

|r_{B}|=d_{D}=e

where a, d and e are measured values.

a=(T_{A}−t_{A})*cₛ

d=(T_{C}−t_{C})*cₛ

e=(T_{D}−t_{D})*cₛ

If, in a third calibration step, the portable electronic device 10A is then placed at, for example, the loudspeaker 4C, then p=r_{C} and:

|r_{C}−r_{A}|=d_{A}=b

|r_{C}−r_{B}|=d_{B}=d

|r_{C}|=d_{D}=f

where b, d and f are measured values.

b=(T_{A}−t_{A})*cₛ

d=(T_{B}−t_{B})*cₛ

f=(T_{D}−t_{D})*cₛ

The three separate calibration steps produce the results:

|r_{A}|=c

|r_{A}−r_{B}|=a

|r_{B}−r_{C}|=d

|r_{C}|=f

|r_{A}−r_{C}|=b

|rₐ|=e

where a b c d e f are now measured, known values.

If the vector displacements r_{A} r_{B} r_{C} and p are 2D vectors having x and y co-ordinates, then this result represents six equations with six unknowns and can be solved to provide r_{A} r_{B} and r_{C}.

Let:

r_{A}=(0,y₁)

r_{B}=(x₂,y₂)

r_{C}=(x₃,y₃)

r_{D}=(0,0)

The position of speaker 4A is (0, c) and the position of speaker 4D is (0, 0).

Calculate the position of speaker 4B:

x²+y²=e² and x²+(y−c)²=a²
a²=x²+(y−c)²=x²+y²−2yc+c²=e²−2yc+c²
2yc=e²+c²−a²
y₂=(e²+c²−a²)/(2c)
x₂=√(e²−y_{B}²) (x₂>0)

Calculate the position of speaker 4C:

x²+y²=f² and x²+(y−c)²=b²
b²=x²+(y−c)²=x²+y²−2yc+c²=f²−2yc+c²
2yc=f²+c²−b²
y₃=(f²+c²−b²)/(2c)
x₃=√(f²−y_{C}²) (x₃>0)

Value d can be used to check if the position was accurate.

(x₂−x₃)²+(y₂−y₃)²=d²

If the vector displacements r_{A} r_{B} r_{C} and p are 3D vectors having x, y and z co-ordinates, then this result represents six equations with nine unknowns and cannot be solved without further constraints. These constraints may arise from constraints on the positions of the speakers so that they have a particular geometry. For example, if the loudspeakers form a rectangle then r_{A} can be represented by 2 co-ordinates y and z, r_{C} can be represented by 2 co-ordinates x and z and r_{B} can be represented by 1 co-ordinate z as it has the same x co-ordinate as r_{C} and the same y co-ordinate as r_{A}. The result consequentially reduces to six equations with five unknowns and can be solved to provide r_{A} r_{B} and r_{C}.

When the portable electronic device 10A is then moved to a general position p

|p−r_{A}|=d_{A}=(t_{A}−T_{A})*c

|p−r_{B}|=d_{B}=(t_{B}−T_{B})*c

|p−r_{C}|=d_{C}=(t_{C}−T_{C})*c

|p|=d_{D}=(t_{D}−T_{D})*c

These equations can be solved to determine p. It will be appreciated that only three of the equations are needed to solve for p. Consequently, reception of beacons is only required from three of the loudspeakers to position the electronic device 10A.

For example, let

d_{A}=d+d₂

d_{B}=d+d₃

d_{C}=d+d₄

d_{D}=d

Calculation if d₂=0 (the distance from 4A is equal to the distance from 4D). Actually, it is never accurate so this calculation can be used for example if—0.1 m<d₂<0.1 m

Define p=(x, y)
y=y₂/2
d²=x²+y² and (x₃−x)²+(y₃−y)²=(d+d₃)²
x₃²−2x₃x+x²+y₃²−2y₃y+y²=d²+2d₃d+d₃²
x₃²−2x₃x+y₃²−2y₃y=2d₃d+d₃²
x₃²−2x₃x+y₃²−2y₃y−d₃²=2d₃d=2d₃√(x²+y²)
Now define z=x₃²+y₃²−2y₃y−d₃²
z−2x₃x=2d₃√(x²+y²)
z²−4zx₃x+4x₃²x²=4d₃²(x²+y²)=4d₃²x²+4d₃²y²
4(x₃²−d₃²)x²−4zx₃x+z²−4d₃²y²=0
x₃² is never equal to d₃², so the quadratic formula x=(−b±√(b²c−4ac))/(2a) can be used; x is either xₐ or x_{b}.
Define x=xₐ or x_{b}

### Define

xₐ=(4zx₃+√((−4zx₃)²−4*4(x₃²−d₃²)*(z²−4d₃²y²)))/(2*4(x₃²−d₃²))

### Define

x_{b}=(4zx₃−√((−4zx₃)²−4*4(x₃²−d₃²)*(z²−4d₃y²)))/(2*4(x₃²−d₃²))
The position of 4C is used to check which is the correct one (less error using the following equation)
(x₄−x)²+(y₄−y)²=(d+d₄)²=(√(x²+y²)+d₄)²

Calculation if d₂≠0

Define p=(xₐ, yₐ) or (x_{b}, y_{b})
x²+y²=d², x²+(y₂−y)²=(d+d₂)², (x₃−x)²+(y₃−y)²=(d+d₃)²
x²+(y²−y)²=(d+d₂)²
x²+y₂²−2y₂y+y²=d²+2d₂d+d₂²
y₂²−2y₂y=2d₂d+d₂²
d=(y₂²−2y₂y−d₂²)/(2d₂)=−(y₂/d₂)y+(y₂²−d₂²)/(2d₂)
Define D_{A}=−(y₂/d₂) and D_{B}=(y₂²−d₂²)/(2d₂) so that d=D_{A}y+D_{B}
(x₃−x)²+(y₃−y)²=(d+d₃)²
x₃²−2x₃x+x²+y₃²−2y₃y+y²=d²+2dd₃+d₃²
x₃²−2x₃x+y₃²−2y₃y=2dd₃+d₃²
x₃²−2dd₃−d₃²+y₃²−2y₃y=2x₃x
x=(x₃²−2dd₃−d₃²+y₃²−2y₃y)/(2x₃)
x=(x₃−2(D_{A}y+D_{B})d₃−d₃²+y₃²−2y₃y)/(2x₃)
x=(x₃²−2d₃D_{A}y−2D_{B}d₃−d₃²+y₃²−2y₃y)/(2x₃)
x=−((y₃+d₃D_{A})/x₃)y+(x₃²−2D_{B}d₃−d₃²+y₃²)/(2x₃)
Define X_{A}=−((y₃+d₃D_{A})/x₃) and X_{B}=(x₃²−2D_{B}d₃−d₃²+y₃²)/(2x₃) so that x=X_{A}y+X_{B}
x²+y²=d²
(X_{A}y+X_{B})²+y²=(D_{A}y+D_{B})²
X_{A}²y²+2X_{A}yX_{B}+X_{B}²+y²=D_{A}²y²+2D_{B}D_{A}y+D_{B}²
(1+X_{A}²−D_{A}²)y²+(2X_{A}X_{B}−2D_{B}D_{A})y+X_{B}−D_{B}²=0
Define Y_{A}=(1+X_{A}²−D_{A}²), Y_{B}=(2X_{A}X_{B}−2D_{B}D_{A}), and Y_{C}=X_{B}²−D_{B}² so that y=Y_{A}y²+Y_{B}y+Y_{C}
The quadratic formula y=(−b±√(b²c−4ac))/(2a) can be used; y is either yₐ or y_{b}.
Define yₐ=(−Y_{B}+√(Y_{B}²Y_{C}−4Y_{A}Y_{C}))/(2Y_{A})
Define y_{b}=(−Y_{B}−√(Y_{B}²Y_{C}−4Y_{A}Y_{C}))/(2Y_{A})
Define xₐ=X_{A}yₐ+X_{B}
Define x_{b}=X_{A}y_{b}+X_{B}
Correct position is either (xₐ, yₐ) or (x_{b}, y_{b}).
The position of 4C is used to check which is the correct one (less error in following equation)
(x₄−x)²+(y₄−y)²=(d+d₄)²=(D_{A}y+D_{B}+d₄)²

The loudspeaker system 3 may be provided by a surround-sound home-entertainment system such as those used for home cinemas, there are typically 5 or 6 loudspeakers 4. These speakers are positioned at front center (FC), left front (LF), right front (RF), surround left (SL), surround right (SR) and optionally rear center (RC). The ‘sweet’ point in a room is the point at which the distance to the LF equals the distance to the FC equals the distance to the RF and at which the distance to the SL equals the distance to the SR. The distance between LF and FC equals the distance between FC and RF and the line between FC and the sweet point bisects the line between SL and SR.

The LF, RF, SL and SR loudspeakers may be used as described previously as the loudspeakers 4A, 4B 4D and 4C respectively, for example. The additional loudspeaker(s) may also be used.

As illustrated in FIG. 1, the loudspeaker system is able to be used by each of the devices 10A, 10B to position themselves within the area/volume 6. Each device may be able to transmit its position to the other devices or to a single other device. Each device or one of the devices will subsequently be able to locate each of the other devices 10 in the area/volume 6. This location information may be used as an input to an application running on the electronic device. For example, the application may be a game and movement of the portable electronic device 10A within the volume/area 6 will move a character of the game within a virtual game space. Thus multiple characters within the game may be moved relative to one another by movement of the electronic devices that control those characters relative to one another within the area/volume 6.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An acoustical positioning system for positioning a portable electronic device comprising:
a loudspeaker system comprising three or more loudspeakers and a control unit operable according to a first time reference wherein the control unit controls the transmission of a series of audio beacons from the loudspeakers, wherein a first beacon is transmitted at a first time of the first time reference from a first speaker, a second beacon is transmitted at a second time of the first time reference from a second speaker, and a third beacon is transmitted at a third time of the first time reference from a third speaker;
at least one portable electronic device operable according to a second time reference and comprising:
synchronisation means for synchronising its second time reference to the first time reference;
a microphone for receiving the transmitted series of audio beacons;
means for detecting the time according to the second time reference at which an audio beacon is received and for identifying the origin of the received audio beacon, wherein the first beacon is received at a fourth time according to the second time reference, the second beacon is received at a fifth time according to the second time reference, and the third beacon is received at a sixth time according to the second time reference; and
means for determining a position of the portable device using relative positions of the first, second and third speakers and the difference between the first time and the fourth time, between the second time and the fifth time, and between the third time and the sixth time.

2. An acoustical positioning system as claimed in claim 1, wherein the audio beacons are transmitted with ultrasonic frequency or frequencies.

3. An acoustical positioning system as claimed in claim 1, wherein the loudspeaker system is part of a surround-sound home-entertainment system.

4. An acoustical positioning system as claimed in claim 3, wherein the surround-sound home-entertainment system has five or six loudspeakers each of which transmits audio beacons.

5. An acoustical positioning system as claimed in claim 1, wherein each loudspeaker transmits an audio beacon in a different channel

6. An acoustical positioning system as claimed in claim 5, wherein the channels are divided using identifiers.

7. An acoustical positioning system as claimed in claim 5, wherein the channels are divided by time.

8. An acoustical positioning system as claimed in claim 1, wherein each beacon comprises information that is modulated on an acoustic carrier signal.

9. An acoustical positioning system as claimed in claim 1, wherein each beacon comprises a time stamp.

10. An acoustical positioning system as claimed in claim 1, wherein the series of audio beacons is a regular ordered series.

11. An acoustical positioning system as claimed in claim 10, wherein the interval between beacons in the series is less than one second.

12. An acoustical positioning system as claimed in claim 1, wherein the portable electronic device comprises a radio frequency transceiver for transmitting the determined position.

13. An acoustical positioning system as claimed in claim 1, wherein the portable electronic device further comprises means for determining the relative positions of the first, second and third speakers.

14. An acoustical positioning system as claimed in claim 13, wherein the means for determining the relative positions of the first, second and third speakers uses the time according to the second time reference at which audio beacons from the first, second and third loudspeakers are received and a nominal position of the electronic device to calculate the relative positions of the first, second and third speakers.

15. An acoustical positioning system as claimed in claim 1, wherein the means for determining the relative positions of the first, second and third loudspeakers and the means for synchronising operate simultaneously.

16. An acoustical positioning system as claimed in claim 1, wherein the means for synchronising uses the time according to the second time reference at which audio beacons from the first, second and third loudspeakers are received and a nominal position of the electronic device to calculate the offset of the second time reference from the first time reference.

17. A portable electronic device, for determining its position via a loudspeaker system that operates according to a first time reference and that transmits a series of audio beacons from loudspeakers, the portable electronic device being operable according to a second time reference and comprising:
synchronisation means for synchronising its second time reference with the first time reference;
a microphone for receiving a transmitted series of audio beacons;
means for detecting the time according to the second time reference at which an audio beacon is received and for identifying the loudspeaker that transmitted the received audio beacon; and
means for determining a position of the portable device using the relative positions of the loudspeakers and the differences between the time of transmission and the time of receipt for a plurality of audio beacons from at least three loudspeakers.

18. A portable electronic device as claimed in claim 17, further comprises means for determining the relative positions of a first loudspeaker, a second loudspeaker and a third loudspeaker.

19. A portable electronic device as claimed in 18, wherein the means for determining the relative positions of the first, second and third loudspeaker uses the time according to the second time reference at which audio beacons from the first, second and third loudspeakers are received and a nominal position of the electronic device to calculate the relative positions of the first, second and third speakers.

20. A portable electronic device as claimed in claim 17, wherein the means for synchronising uses the time according to the second time reference at which audio beacons from the first, second and third loudspeakers are received and a nominal position of the electronic device to calculate the offset of the second time reference from the first time reference.

21. A portable electronic device as claimed in claim 17, wherein the means for determining the relative positions of the first, second and third loudspeakers and the means for synchronising operate simultaneously.

22. A portable electronic device as claimed in claim 17, wherein the portable electronic device comprises a radio frequency transceiver for transmitting the determined position.

23. A computer program comprising computer program instructions which when loaded into a processor provide:
synchronisation means for synchronising a local time reference with a remote time reference;
means for processing the output of a microphone to detect the times according to the local time reference at which audio beacons transmitted from loudspeakers are received by the microphone and for identifying, for each received audio beacon, the loudspeaker that transmitted that audio beacon; and
means for determining a position of the portable device using relative positions of the loudspeakers and the differences between the time of transmission and the time of receipt for a plurality of audio beacons from at least three loudspeakers.
